(19) United States
(12) Patent Application Publication
(10) Pub. No.: US 2024/0337823 A1
(43) Pub. Date: Oct. 10, 2024

(54) OPTICAL SCAN MULTIPLIER AND USES THEREOF

(71) Applicant: Trustees of Boston University, Boston, MA (US)

(72) Inventors: Sheng Xiao, Brighton, MA (US); Jerome Charles Mertz, Newton, MA (US)

(73) Assignee: Trustees of Boston University, Boston, MA (US)

(21) Appl. No.: 18/578,671

(22) PCT Filed: Jul. 14, 2022
(86) PCT No.: PCT/US2022/037125

§ 371 Date: Jan. 11, 2024

Related U.S. Application Data
(60) Provisional application No. 63/222,031, filed on Jul. 15, 2021.

(51) Int. Cl. G02B 21/00; G02B 5/136

(52) U.S. Cl. CPC G02B 21/0048; G02B 5/136; G02B 21/006; G02B 2207/114

(57) ABSTRACT

A scan multiplier system for optical scanning includes an inertial scanning unit for receiving an incident beam and scanning the incident beam to generate a scanned beam defining a scanned line rate. A scan multiplier unit receives the scanned beam from the inertial scanning unit, the scan multiplier unit including one or more optical elements for redirecting the scanned beam back toward the inertial scanning unit, the inertial scanning unit receiving the reflected beam from the optical element and generating a rescanned beam, the rescanned beam defining a rescanned line rate different from the scanned line rate. The scan multiplier system can be used with a laser scanning microscope system, such as a two-photon microscope system, a confocal microscope system, or other such microscope system.

### RELATED APPLICATIONS

This application is related to and claims the benefit of U.S. Provisional Application No. 63/222,031, filed on Jul. 15, 2021, the entire contents of which are incorporated herein by reference.

### GOVERNMENT SUPPORT

This invention was made with government support under Contract No. NS116139 awarded by the National Institutes of Health. The government has certain rights in the invention.

### BACKGROUND

### 1. Technical Field

The present disclosure is related to optical scanning devices and methods and, more particularly, to an optical scan multiplier device and method.

### 2. Discussion of Related Art

Mirror-based optical scanners are the most commonly used laser beam steering solutions for a wide range of applications, such as laser scanning microscopes or LiDAR. They are generally cost-effective, easy to use, have high light transmission as well as high scanning throughput (defined as the maximum number of resolvable angles/spots it can scan per unit time). However, since such scanners rely on the physical movement of scan mirrors, their maximum scanning rate and scanning throughput are fundamentally limited by inertia.

### SUMMARY

According to a first aspect, the technology of the disclosure is directed to a scan multiplier system for optical scanning. The scan multiplier includes an inertial scanning unit for receiving an incident beam and scanning the incident beam to generate a scanned beam defining a scanned line rate. A scan multiplier unit receives the scanned beam from the inertial scanning unit, the scan multiplier unit including one or more optical elements for redirecting the scanned beam back toward the inertial scanning unit, the inertial scanning unit receiving the reflected beam from the optical element and generating a rescanned beam, the rescanned beam defining a rescanned line rate different from the scanned line rate.

According to some exemplary embodiments, the incident beam, the scanned beam, and the rescanned beam are optical light beams.

According to some exemplary embodiments, the rescanned line scan rate of the rescanned beam is greater than the scanned line rate.

According to some exemplary embodiments, the scan multiplier unit comprises a scan lens and a retroreflector array.

According to some exemplary embodiments, the optical element in the scan multiplier unit comprises a reflective element.

According to some exemplary embodiments, the optical element in the scan multiplier unit comprises a plurality of reflective elements at a predetermined pitch.

According to some exemplary embodiments, the optical element in the scan multiplier unit comprises a plurality of reflective elements at a variable pitch.

According to some exemplary embodiments, the optical element in the scan multiplier unit comprises a refractive element.

According to some exemplary embodiments, the optical element in the scan multiplier unit comprises a plurality of refractive elements at a predetermined pitch.

According to some exemplary embodiments, the optical element in the scan multiplier unit comprises a plurality of refractive elements at a variable pitch.

According to some exemplary embodiments, the optical element comprises a one-dimensional array of reflective elements.

According to some exemplary embodiments, the optical element comprises a one-dimensional array of refractive elements.

According to some exemplary embodiments, the optical element comprises a one-dimensional tilted array of reflective elements.

According to some exemplary embodiments, the optical element comprises a one-dimensional tilted array of refractive elements.

According to some exemplary embodiments, the optical element comprises a two-dimensional array of reflective elements.

According to some exemplary embodiments, the optical element comprises a two-dimensional array of refractive elements.

According to some exemplary embodiments, the system further includes a plurality of optical elements for separating the incident light beam from the rescanned light beam.

According to another aspect, the technology of the disclosure is directed to a laser scanning microscope system. The system includes a light source for generating an incident light beam and an inertial scanning unit for receiving the incident light beam and scanning the incident light beam to generate a scanned light beam defining a scanned line rate. A scan multiplier unit receives the scanned light beam from the inertial scanning unit, the scan multiplier unit including an optical element for redirecting the scanned light beam back toward the inertial scanning unit, the inertial scanning unit receiving the reflected light beam from the optical element and generating a rescanned light beam, the rescanned light beam defining a rescanned line rate different from the scanned line rate.

According to some exemplary embodiments, the system further includes a plurality of optical elements for separating the incident light beam from the rescanned light beam.

According to some exemplary embodiments, the system further includes a scanner for scanning the rescanned beam along a slow axis.

According to some exemplary embodiments, the system further includes an objective for focusing the rescanned light beam onto a focused spot that scans over a sample.

According to some exemplary embodiments, the system further includes a detector for detecting light from a sample.

According to some exemplary embodiments, the detector comprises a two-dimensional array of detector elements.

According to some exemplary embodiments, the detector comprises a one-dimensional array of detector elements.

According to some exemplary embodiments, the microscope is a confocal microscope.

According to some exemplary embodiments, the microscope is a two-photon microscope.

### BRIEF DESCRIPTION OF THE DRAWINGS

The present disclosure is further described in the detailed description which follows, in reference to the noted plurality of drawings by way of non-limiting examples of embodiments of the present disclosure, in which like reference numerals represent similar parts throughout the several views of the drawings.

FIG. 1 is a schematic diagram of a system for scan rate and throughput enhancement of a mirror-based laser beam scanner with the use of a one-dimensional (1D) retroreflector array, according to some exemplary embodiments.

FIG. 2 is a graph illustrating scan angle as a function of time, according to some exemplary embodiments.

FIG. 3 is a schematic diagram of another system for scan rate and throughput enhancement of a scanner, doubling the scanning field of view using a single retroreflector, according to some exemplary embodiments.

FIG. 4 is a schematic diagram of another system for scan rate and throughput enhancement of a scanner, using a unidirectional retroreflector array, according to some exemplary embodiments.

FIG. 5 is a schematic diagram of a system for scan frame rate improvement in a two-dimensional (2D) scanner, according to some exemplary embodiments.

FIG. 6 is a schematic diagram of a system for realizing 2D laser beam scanning with a 1D scanner, according to some exemplary embodiments.

FIG. 7A is a schematic diagram illustrating 2D laser beam scanning with a 1D scanner, including scanning beam incident position and corresponding exit position of a retroreflected beam, using a tilted microlens array, according to some exemplary embodiments. FIG. 7B is a schematic diagram illustrating 2D laser beam scanning with a 1D scanner, including 2D scanning field of view when using the 1D scanner, according to some exemplary embodiments.

FIG. 8 is a schematic functional diagram illustrating an approach for separating an incident beam and a rescanned beam, according to some exemplary embodiments.

FIG. 9 is a schematic diagram of an unfolded version of the system illustrated in FIG. 4 while the scanning beam transmits through the system in a single forward pass, according to some exemplary embodiments.

FIG. 10 is a schematic diagram of a two-photon microscope for 1 kHz frame rate imaging, using a scan multiplier unit according to some exemplary embodiments.

FIGS. 11A-11C illustrate images generated using the microscope of FIG. 10 and corresponding calcium dynamics over a three-minute recording, according to some exemplary embodiments.

FIG. 12 is a schematic diagram of a two-photon microscope for 16 kHz frame rate imaging, using a scan multiplier unit with tilted lenslet array, according to some exemplary embodiments.

FIG. 13A-13G illustrate imaging aspects using the microscope of FIG. 12, according to some exemplary embodiments.

FIGS. 14A and 14B illustrate an approach to separating and outgoing rescanned beam from an incident beam, as applied to confocal microscopy, according to some exemplary embodiments.

FIG. 15 is a schematic diagram of a confocal microscope system 1000 using a scan multiplier unit 1002 according to some exemplary embodiments.

### DETAILED DESCRIPTION

Described herein are an apparatus and method to multiply the scanning rate of a mirror-based mechanical scanner by more than an order of magnitude, enabling ultrafast one-dimensional (1D) scan beyond the inertia limit, while also doubling the scanning throughput. The scan rate multiplication is flexible. A variant of the technique is also able to perform two-dimensional (2D) laser beam scanning by using only a single 1D optical scanner, achieving 2D frame scanning rate at the speed of 1D scanning. The technology described herein is useful for general applications that require high-speed high-throughput laser scanning.

A fundamental property of an optical scanner is its scanning throughput Q. which can be defined as the number of resolvable angles/spots that it is able to scan per unit time. This property is directly related to the scanner characteristics of beam scan angle θ, scan rate (scan frequency) R and aperture size D. To find the maximum throughput of an optical scanner, it is assumed an incident laser beam of wavelength λ occupies the full aperture D of the scanner, the natural divergence (angular resolution) (1) of the beam is

$$Δθ = \frac{λ}{D} . \qquad ( 1 )$$

With a maximum of scan angle θ, the number of resolvable angles during a single scan sweep is

$$n = \frac{Θ}{Δθ} = \frac{Θ D}{λ} . \qquad ( 2 )$$

At a scan rate of R, the number of independent angles the scanner can scan per second, i.e., scanning throughput, can be expressed as

$$Q = nR = \frac{Θ DR}{λ} . \qquad ( 3 )$$

In some applications, a Fourier transform lens with a focal length f is used to focus the laser beam and convert angular scan into spatial scan. Under paraxial approximation, the lateral scanning field-of-view L is:

$$L = f Θ , \qquad ( 4 )$$

and the spot size of the focused laser beam according to Abbe criterion is

$$Δ d = \frac{λ}{2 NA} = \frac{λ}{2 ( D / 2 f )} , \qquad ( 5 )$$

where NA=D/2f is the numerical aperture of the focused beam (1). From the above equations, the expression of throughput in terms of number of resolvable spots can be derived as:

$${Q}^{′} = \frac{L}{Δ d} R = \frac{Θ DR}{λ} . \qquad ( 6 )$$

Therefore, despite the difference of a Fourier transform lens, both Eq. (3) and Eq. (6) are essentially equivalent and interchangeable. For the remainder of this description, we do not explicitly differentiate these two definitions in terms of resolvable angles or resolvable points. Mirror-based mechanical scanners, such as piezo tip/tilt mirror, micro-electromechanical system (MEMS) mirror (2), galvonometric scanners (3), resonant scan mirrors (3), and polygonal scanners (4), are the most commonly used laser beam steering solutions. Since the laser beam is deflected by a mirror, these scanners are typically low-loss, highly achromatic (operational over a broad wavelength), compatible with a wide range of laser sources, and can easily be integrated into existing systems.

However, since the laser beam is steered by physically rotating the mirror, their performance is fundamentally limited by inertia: increasing scan rate R generally requires reducing scan angle θ and mirror aperture size D. For high-speed scanning applications, this trade-off typically leads to a reduction in throughput (defined by Eq. 3 and Eq. 6). For example, with a 5 mm aperture size, while a 8 kHz Cambridge Technology (5) resonant scanner is able to scan a 26° field-of-view, a faster 12 kHz resonant scanner is only able to scan a 10° field-of-view, which translates to a decrease of 42% throughput. Further limited by inertia, continuing to increase scan rate for single-facet mirrors is difficult without using micro-sized mirrors. For a polygonal scanner that uses multi-facet mirrors, one is able to achieve a much faster speed at ˜100 kHz by using a high facet count polygonal mirror. However, the aforementioned trade-off still exists: with a fixed polygonal mirror radius and rotation speed, its throughput decreases roughly linearly with increasing scan rate. This is because in order to achieve N times the scanning rate, one needs to have N times the facet counts on the polygonal mirror, which reduces both the scan angle θ and mirror aperture D by N times, therefore the throughput according to Eq. 3 or Eq. 6 is reduced N times. Although larger mirror aperture can be achieved by using a larger-radius polygonal mirror, the mirror mass will increase quadratically which inevitably leads to reduced rotation speed and thus scanning rate. Therefore, although many applications can benefit from using a scanner with both high scan rate and high throughput, mechanical scanners usually need to compromise one for another. In addition to low throughput, high speed mechanical scanners are limited to a maximum scan rate of ˜100 kHz due to inertia. As a result, mirror-based mechanical scanners have rarely been used for ultrahigh-speed laser scanning applications at a scanning rate >100 kHz.

An alternative to mechanical scanners are solid-state scanners including electro-optic deflectors (EOD) (6) and acousto-optic deflectors (AOD) (7, 8). These optical scanners contain no moving parts because they only rely on the modulation of refractive index of the optical crystals for beam deflection. Thus they are inertia-free and able to operate at scan rates in the hundreds of kHz (9). However, they are generally more costly and more complicated to operate due to intrinsic aberrations and chromatic dispersions. For example, for ultrafast laser applications, it is often necessary to synchronize the AOD operation with individual laser pulses to avoid cylindrical lens effect. Such characteristic makes AOD more suitable for random access scanning (10) of discrete spots rather than smooth scanning of a continuous line. In addition, both AOD and EOD have small aperture size and deflection angles, due to the limitations of acoustic fill time or applied high voltage, leading to smaller throughput than mechanical scanners.

All of the aforementioned techniques are generally used for 1D scanning. For applications that require 2D scanning, this is usually achieved by using a single tip/tilt mirror with 2D motions or two optical scanners arranged orthogonally. Since a 2D field-of-view is typically covered by sequential line-by-line scanning, 2D scanning rate is inevitably lower than the highest 1D scanning rate, determined by the mirror motion along the fast scanning axis. This means that for a 2D area with N independent lines, the 2D scanning speed is only 1/N times the rate of the fast axis scanner.

The present disclosure is directed to a new technique, i.e., new apparatus and method, for scan rate and throughput enhancement of mirror-based optical scanners. In the technique described herein, instead of achieving beam scanning by one-time deflection though the scan mirror as generally done in scanning applications, a double-pass technique in which the deflected beam is reflected by a scan multiplier unit back to the same mirror and deflected a second time is utilized. In some exemplary embodiments of the technology as described herein the scan multiplier unit is an optical system that is able to introduce an angular offset to the deflected beam and to retroreflect it back to the scan mirror for second-time deflection, referred to herein as “rescanning.”

Certain features and elements of the technology distinguish the technology from prior approaches, these novel and nonobvious features and elements including at least: (1) the ability to surpass the inertia limit and increase the scanning rate of the scanner by more than an order of magnitude, up to hundreds of kilohertz or megahertz; (2) the ability to enhance the throughput of the scanner by a factor of two; (3) scan rate enhancement is flexible, particularly when enhancement equals to 1, i.e., no enhancement; that is, the ability to double the scan angle and therefore double the scan field-of-view of the used scanner; (4) the ability to perform 2D laser scanning using only a 1D scanner, therefore achieving a 2D area scanning rate at the rate of 1D line scan; (5) as a mirror-based technology, it shares all the advantages of a mirror-based scanner such as low-loss, high achromaticity, and no requirement for specialized laser sources or beam profiles; (6) contrary to mechanical scanners, the present technology has the benefit of having both high scan rate that can be faster than any mechanical scanners, and high throughput that is comparable to a medium or slow speed mechanical scanner.

Laser beam scanners is a fundamental technology used in numerous areas such as imaging, biomedical, display, material processing, navigation. Since the present technology is able to improve the scan rate and throughput of a laser beam scanner, it can be used to enhance the performance of a basic laser scanning unit. When incorporated into an existing product, it can improve the speed of the respective process, e.g., frame rate of imaging and display applications, processing time for material processing applications. It can also increase the covered area e.g., field-of-view for imaging or display applications. Also, due to the advantages of achromaticity and compatibility with different laser sources and beam profiles, the present technology is generally applicable to a wide range of applications that utilize mirror-based scanners.

Some systems in which the present technology can be applied include:
Basic laser scanner. Pizeo tip/tilt mirror, micro-electromechanical system (MEMS) scanning mirror, galvonometric scanner, resonant scan mirror, polygonal scanner
Imaging. Non-line-of-sight imaging, time-of-flight (ToF) imaging
Biomedical. Laser scanning microscopy, ophthalmology, laser scanning cytometry
Remote Sensing. Light detection and ranging (LiDAR) systems, 3D surveying, terrestrial laser scanning
Display. Head-up display (HUD), laser scanning projector, near eye display
Material Processing. Three-dimensional (3D) printing, laser micro-machining, laser surface cleaning, laser cutting/welding

For a standard mirror-based scanner, a laser beam is incident on the mirror surface and is deflected in another direction, where the deflection angle depends on the angle between the mirror normal and the incident beam. By physically rotating the scan mirror, the deflection angle will vary, thus achieving a scanning laser beam. In some cases, this angular scanning is converted into spatial scanning with the use of a scan lens, where the laser beam is focused into a spot.

The present technology is based on a mechanical mirror scanner, but, instead of steering the incident beam with a single pass deflected by the mirror, a double-pass approach, in which a beam is first scanned by a mirror into a scan multiplier unit and then subsequently rescanned by the same mirror, is utilized. While rescanning has been used in techniques such as reflectance confocal microscopy (13), rescanning in such systems only results in a static beam parallel to the incident beam due to the cancelling of scan angles. In contrast, in the present technology, the scan multiplier unit is able to retroreflect the initial scanned beam with an additional angular offset Δθ before being rescanned by the mirror, resulting in an extra angular offset Δθ of the rescanned beam with respect to the incident beam. If this angular offset varies depending on the scanning angle, then the angle of the rescanned beam will also vary accordingly. If, additionally, this varying offset angle is periodic, then the rescanned beam will have the same periodically varying angles, essentially creating a periodic scanning pattern on the rescanned beam.

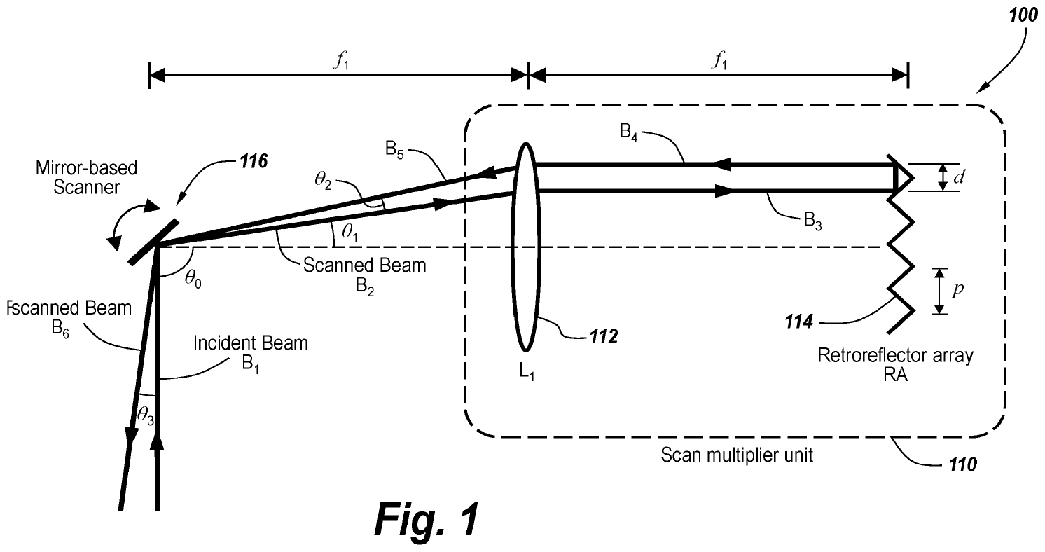

In some exemplary embodiments, the technology of the present disclosure provides scan rate enhancement for 1D scanners. FIG. 1 is a schematic diagram of a system 100 for scan rate and throughput enhancement of a mirror-based laser beam scanner with the use of a 1D retroreflector array, according to some exemplary embodiments. In the embodiment of FIG. 1, scan multiplier unit 110 is realized by the combination of a telecentric scan lens L1 112 and a 1D retroreflector array 114. An incident beam B1 is deflected by a mirror-based scanner 116, resulting in a scanned beam B₂ that is angularly scanning at an angle θ₁∈[−θₘₐₓ, θₘₐₓ], depending on the mirror rotation. Here [−θₘₐₓ, θₘₐₓ] is the maximum scanning range centered at θ₁ =0. For simplicity, it is assumed here that the scanner completes a single 1D scan from −θₘₐₓ to θₘₐₓ between time 0≤t≤1/R, and the scanning angle of B₂ varies linearly with time t:

$${θ}_{1} ( 0 \leq t \leq 1 / R ) = ( 2 Rt - 1 ) {θ}_{max} , \qquad ( 7 )$$

where R is the scan rate (frequency) of the scanner.

The scanned beam B₂ is collected by a telecentric scan lens L1 112 located at distance ƒ₁ from mirror-based scanner 116, whose function is to convert angular scanning into spatial scanning, resulting in a focused beam B₃ that is laterally scanning across retroreflector array RA 114. The incident position of B₃ on RA 114 is given by:

$${y}_{i} ( t ) = {f}_{1} tan ( {θ}_{1} ) = {f}_{1} tan [ ( 2 Rt - 1 ) {θ}_{max} ] \qquad ( 8 )$$

Here ƒ₁ is the focal length of lens L1 112.

By definition, a retroreflector reflects a beam back to its source along the parallel direction of the incident beam. As a result, reflected beam B₄ will be parallel to B₃, but with a lateral offset d depending on B₃'s incident position yᵢ(t). In some exemplary embodiments, retroreflector array 114 is a 1D periodic retroreflector array 114 made of hollow roof prism mirrors with pitch p. In some exemplary embodiments, the lateral position of the apex of each retroreflector can be written as:

$$P ( y ) = {\sum }_{m = 1}^{M} δ ( y - mp - Δ {y}_{RA} ) \qquad ( 9 )$$

where M∈{1, 2, 3, . . . } is the number of individual retroreflectors within array 114, Δy_{RA} is an overall vertical shift of the array. In this case, the vertical offset distance d is depending on the vertical distance of B3 position yᵢ(t) to the closest apex of the retroreflector, which can be expressed as:

$$d = - 2 [ ( {y}_{i} ( t ) + Δ {y}_{( RA )} - p / 2 ) mod p ] + p \qquad ( 10 )$$

where (a mod b) is the modulo operator.

The retroreflected beam B4 then reaches the lens L1 112, which converts its lateral offset d into an angular offset θ₂ with respect to the scanned beam B₂, which is given by:

$${θ}_{2} = arctan [ ( {y}_{i} ( t ) + d ) / {f}_{1} ] - arctan [ {y}_{i} ( t ) / {f}_{1} ] \qquad ( 11 )$$

Assuming d is sufficiently small, then it can be simplified to:

$${θ}_{2} = d cos {θ}_{1} / {f}_{1} = \frac{- 2 [ ( {y}_{i} ( t ) + Δ {y}_{RA} - p / 2 ) mod p ] + p}{{f}_{1} / cos {θ}_{1}} \qquad ( 12 )$$

It is noted that the distance between L1 112 and RA 114 equals f₁ so that the resulting beam B₅ remains collimated and has the same beam width as the incident beam B₁.

After beam B₅ finally reaches the scan mirror in mirror-based scanner 116 and is being scanned again, beam B6 will have the same angular offset with respect to the original incident beam B₁:

$${θ}_{3} = - {θ}_{2} = \frac{2 [ ( {y}_{i} ( t ) + Δ {y}_{RA} - p / 2 ) mod p ] - p}{{f}_{1} / cos {θ}_{1}} \qquad ( 13 )$$

From Eq. (8) and Eq. (13), the dependence of the rescan angle of beam B6 as a function of the scan angle of the original scanning beam B2 is determined as:

$${θ}_{3} ( {θ}_{1} ) = ( 2 [ ( {f}_{1} tan ( {θ}_{1} ) + Δ {y}_{RA} - p / 2 ) mod p ] - p ) / ( {f}_{1} / cos {θ}_{1} ) \qquad ( 14 )$$

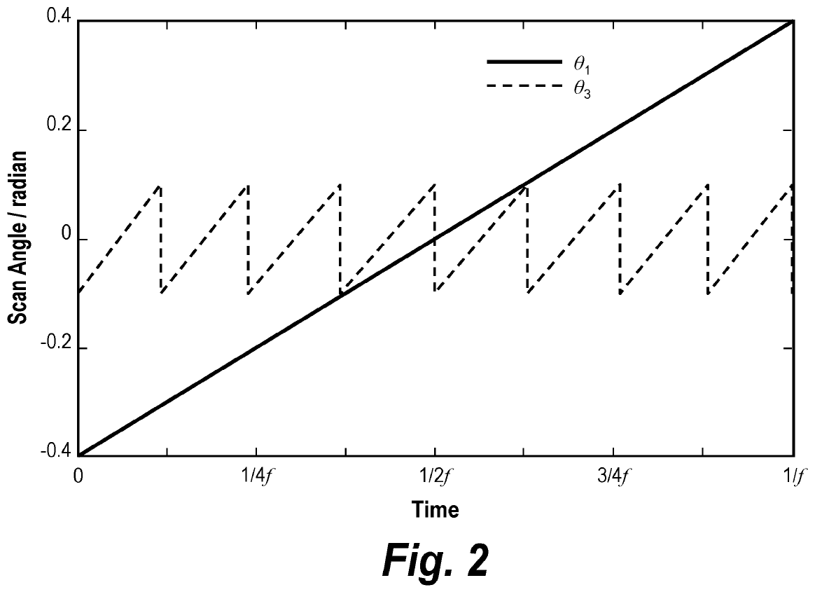

FIG. 2 is a graph illustrating scan angle as a function of time, according to some exemplary embodiments. FIG. 2 shows both the scan angle θ₁ and rescan angle θ₃ as a function of time during a single scanner sweep t∈[0,1/R]. For simplicity, if the pitch and the vertical shift of the retroreflector array 114 are chosen so that Mp=2f₁ tan (θₘₐₓ), and ƒ₁ tan (θₘₐₓ)+ΔY_{RA}+p/2=0, where M∈{1, 2,3, . . . } a positive integer, then during a single line scan where θ₁ scans once from −θmax to θmax, according to Eq. 14, the rescan angle θ₃ scans from

$$- \frac{p}{{f}_{1}} to \frac{p}{{f}_{1}}$$

M times.

In essence, a function of scan multiplier unit 110 is to retroreflect the scanned beam B2 with a periodic angular offset θ₂ depending on the scan angle θ₁, resulting in the periodic varying angle θ₃ between the rescanned beam B₆ and incident beam B1, and therefore leading to the angular scanning motion of beam B6. Depending on the number of retroreflectors that cover the original scanning area, the scan rate of a mechanical scanner can be increased M>1 times.

Throughput enhancement. According to Eq. (3), for a standard optical scanner with an aperture size of D, scan frequency R, and maximum scan range θ₁∈[−θₘₐₓ, θₘₐₓ], its maximum throughput for a laser wavelength A is:

$${Q}_{0} = \frac{2 {θ}_{max} DR}{λ} \qquad ( 15 )$$

According to the present disclosure, where the scan rate is increased to MR with a scan range of θ₃∈[−p/ƒ₁, p/f₁], the throughput becomes:

$${Q}_{1} = \frac{2 pMDR}{{f}_{1} λ} \qquad ( 16 )$$

Under paraxial approximation (1), Mp≈2f₁θₘₐₓ, the above equation Eq. (16) can be further simplified into

$${Q}_{1} \approx \frac{4 {θ}_{max} DR}{λ} = 2 {N}_{1} , \qquad ( 17 )$$

which means that the present technology is able to increase the throughput of a mechanical scanner by a factor of two.

Scan field-of-view enhancement. As a result of the doubled scan throughput, when setting M=1, i.e., retroreflector array RA 114 includes a single retroreflector, the maximum scanning range of a scanner can be doubled. This can be seen from Eq. 11 by setting the size of a single retroreflector equal to the maximum scan range p=2f₁ tan (θₘₐₓ), and appropriate vertical offset so that the retroreflector is centered along the optical axis f₁ tan (θₘₐₓ)+Δy_{RA}+p/2=0:

$${θ}_{3} ( {θ}_{1} ) = - 2 {θ}_{1} ∈ [ - 2 {θ}_{max} , 2 {θ}_{max} ] \qquad ( 18 )$$

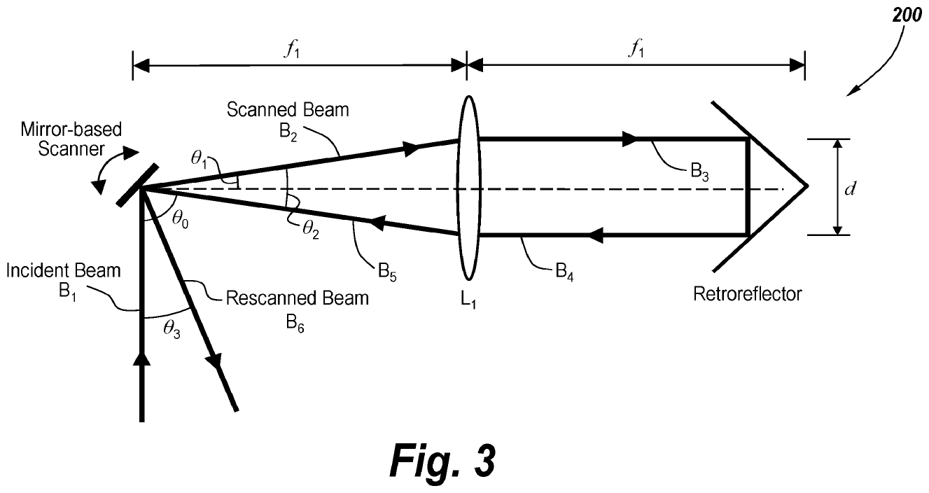

Therefore with the technology of the present disclosure, the maximum scan field-of-view can be doubled from [−θₘₐₓ, θₘₐₓ] to [−2θₘₐₓ, 2θₘₐₓ]. An illustration of this system is shown in FIG. 3, which is a schematic diagram of a system 200 for scan rate and throughput enhancement of a scanner, doubling the scanning field of view using a single retroreflector, according to some exemplary embodiments.

It is noted that optical systems such as non-telecentric scan lens or non-unit magnification 4f system can also be used to adjust the scan field-of-view (θ or L) and laser beam/spot size (Δθ or θd), however they will not alter the scanner throughput Q or the scan rate R. The benefit of using our technique here is the doubled throughput that is coming along with the doubled field-of-view. Therefore, the present technology produces twice the number of resolvable angles/spots compared to a tradition technique. It is understood that other optical systems can be used after the present system of the disclosure to further adjust the scan field-of-view or laser beam/spot size; however, the scan throughput will remain doubled.

Implementation with a unidirectional retroreflector array. Retroreflectors are generally designed for a large acceptance angle, so that beams over a wide incident angle can be reflected back along the same direction. However, in the case of the present technology, the incident beam B₃ is limited to the normal direction of the retroreflector array. This allows more flexibility in terms of the retroreflector design, which only needs to be operational for normal incident beams.

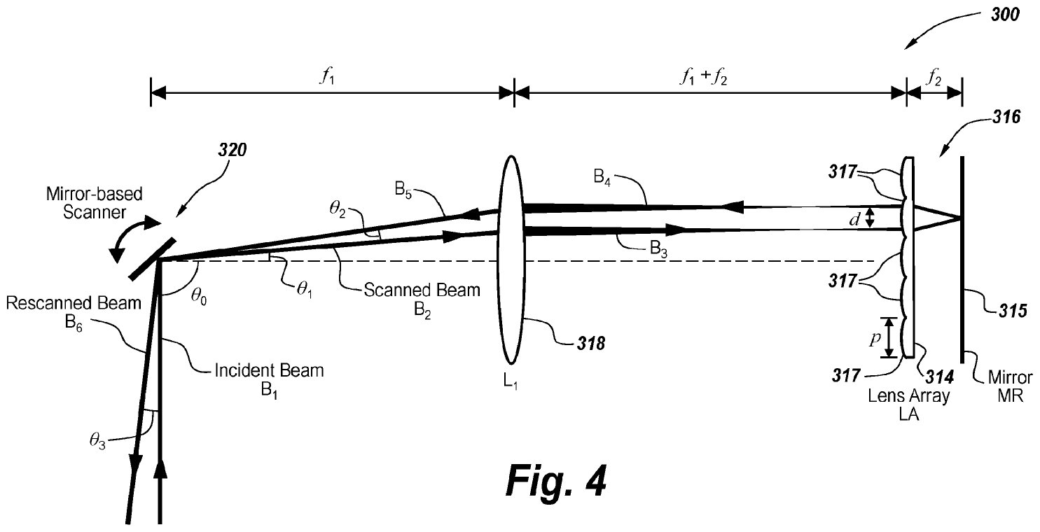

FIG. 4 is a schematic diagram of another system 300 for scan rate and throughput enhancement of a scanner, using a unidirectional retroreflector array, according to some exemplary embodiments. FIG. 4 shows an implementation with a unidirectional retroreflector array 316 including a 1D lens array LA 314 and a planar mirror (MR) 315. It is noted that the terms “lens,” “microlens,” and “lenslet” are used interchangeably in the present disclosure to refer to arrays of lenses, microlenses, and lenslets. Here it is assumed that LA 314 includes M of the same lenses 317 aligned vertically with a pitch p, and the focal length of each individual lens 317 is f₂. The distance between lens L1 318 and LA 314 equals f₁+f₂, and MR 315 is placed at a distance f₂ behind the lens array 314. In this way, the retroreflected beam B5. and consequently B6. will remain collimated and have the same beam width as the incident beam B1.This implementation is largely similar to FIG. 1 except the retroreflector array RA 114 of FIG. 1 is replaced with the combination of lens array 314 and planar mirror MR 315. Therefore, the operational principle is the same to what has been described above for FIG. 1: with M individual lenses 317 that cover the total scanning area, for a single scanner sweep that scans θ₁ from −θₘₐₓ to θₘₐₓ, the rescanned beam will sweep M times with a scanning angle from

$$- \frac{p}{{f}_{1}} to \frac{p}{{f}_{1}} .$$

The scanner throughput is also increased by a factor of two.

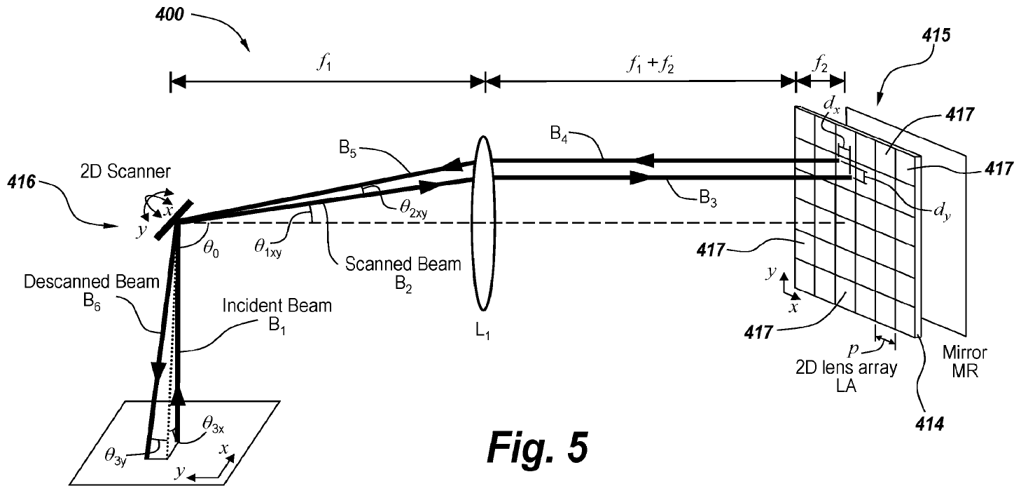

Scan rate enhancement for 2D scanners. While detailed descriptions above are related to improving linear scan rate with the use of 1D scanners, the technology can also be generalized to 2D scanners for improvement of 2D area scan rate. This would be useful for single mirror 2D scanning systems such as tip/tilt piezo mirror, tip/tilt MEMS mirror, or dual mirror 2D scanning systems such as galvo-resonant scanner. FIG. 5 is a schematic diagram of a system 400 for scan frame rate improvement in a two-dimensional (2D) scanner, according to some exemplary embodiments. The system 400 shown in FIG. 5, is essentially the same as system 300 in FIG. 4. except system 400 includes a 2D scanner 416 and a 2D lens array 414. In the embodiment of FIG. 5, a unidirectional retroreflector array 415 is illustrated, although other 2D array designs, such as a corner cube retroreflector array or a cat's eye retroreflector array can also be used. It is also assumed that the 2D lens array 414 is made of M×M individual square lenses 417 arranged orthogonally with pitch p and focal length f2.

With assumptions that for a 2D scanner with a scan range of θ_{1x,1y}∈[−θₘₐₓ, θₘₐₓ], and Mp=2f₁ tan (θₘₐₓ), for a single scanning of B₂ across the maximum square scan range, the rescanned beam B₆ scans M times over the square region defined by θ_{3x,3y}∈[−p/f₁, p/f₁]. The subscripts (*)_{x,y} represent offset angles along the x and y axis respectively, as illustrated in FIG. 5. The maximum throughput is also increased by a factor of two in both x and y directions.

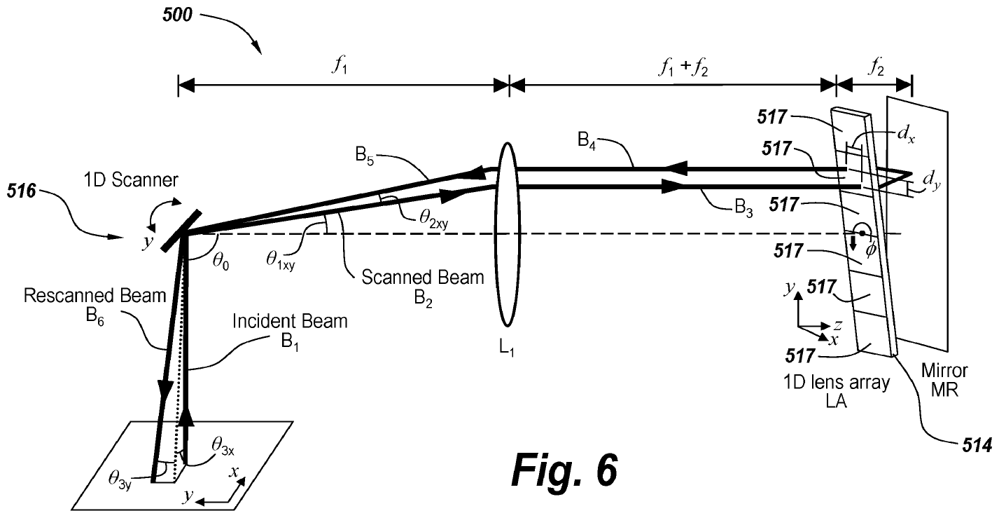

2D scanning with 1D scanners. FIG. 6 is a schematic diagram of a system 500 for realizing 2D laser beam scanning with a 1D scanner, according to some exemplary embodiments. This system 500 is the same as system 300 of FIG. 4, except that the 1D lens array LA 514 of FIG. 6 is rotated for an angle ϕ along the optical axis (z-axis), as shown in FIG. 6. To find the positions of rescanned beam B6. similar notations as in previous system descriptions are adopted: the 1D scanner scans beam B2 from −θₘₐₓ to θₘₐₓ during a single sweep 0≤t≤1/R at constant speed, where R is the scan frequency of the scanner. Therefore, the scanning position of B3 at lens array 514 as a function of time is:

$${x}_{i} ( t ) = 0 \qquad ( 19 )$$

$${y}_{i} ( t ) = {f}_{1} tan {θ}_{1} = {f}_{1} tan [ 2 ( Rt - 1 ) {θ}_{max} ] \qquad ( 20 )$$

It is assumed that the 1D lens array includes M individual squared lenses 517, each with pitch p and focal length f₂. The center position of each individual lens 517 can be expressed as:

$$P ( x , y ) = {\sum }_{m = 1}^{M} δ [ y - ( mp + Δ {y}_{RA} ) cos ϕ ] \cdot δ [ x - ( mp + Δ {y}_{RA} ) sin ϕ ] \qquad ( 21 )$$

Here Δy_{RA} is an overall vertical shift of lens array LA 514 so that it centers with respect to the optical axis.

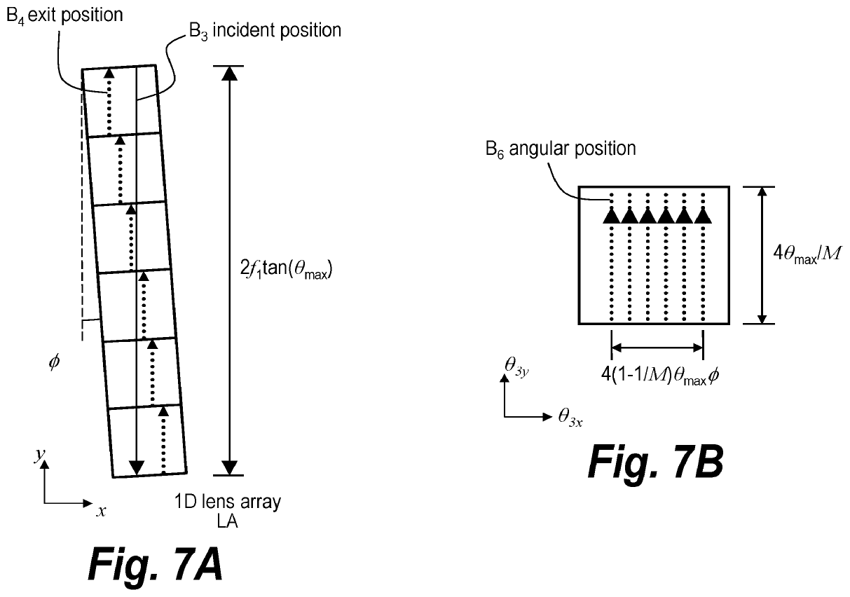

From Eq. (20) and Eq. (21), the horizontal (x-axis) and vertical (y-axis) offset of the retroreflected beam B4 with respect to the incident beam B3 when B3 is within the boundaries of m^{th} lens:

$${d}_{x} = 2 ( mp + Δ {y}_{RA} ) sin ϕ \qquad ( 22 )$$

$${d}_{y} = 2 [ - {y}_{i} ( t ) + ( mp + Δ {y}_{RA} ) cos ϕ ] \qquad ( 23 )$$

$$m = ⌈ \frac{{y}_{i} ( t ) cos ϕ - Δ {y}_{RA} - p / 2}{p} ⌉ , \qquad ( 24 )$$

where ┌*┐ is the ceiling function. This is illustrated in FIG. 7A, which is a schematic diagram illustrating 2D laser beam scanning with 1D scanner 516, including scanning beam incident position and corresponding exit position of a retroreflected beam, using tilted lenslet array 514, according to some exemplary embodiments. FIG. 7B is a schematic diagram illustrating 2D laser beam scanning with 1D scanner 515, including 2D scanning field of view when using 1D scanner 516, according to some exemplary embodiments. Using the relationship between lateral beam offset dry and the rescanned angle θ_{3xy}:

$${θ}_{3 x} = - {θ}_{2 x} = - arctan ( {d}_{x} / {f}_{1} ) \qquad ( 25 )$$

$${θ}_{3 y} = - {θ}_{2 y} = - arctan [ \frac{{y}_{i} ( t ) + {d}_{y}}{{f}_{1}} ] + arctan [ \frac{{y}_{i} ( t )}{{f}_{1}} ] \qquad ( 26 )$$

For small dₓ/f₁ and d_{y}/f₁, the 2D rescanned angle as a function of 1D scanning angle θ₁ is

$${θ}_{3 x} ( {θ}_{1} ) = - 2 [ m ( {θ}_{1} ) \cdot p + Δ {y}_{RA} ] sin ϕ / {f}_{1} \qquad ( 27 )$$

$${θ}_{3 y} ( {θ}_{1} ) = - 2 \{ {f}_{1} tan {θ}_{1} - [ m ( {θ}_{1} ) \cdot p + Δ {y}_{RA} ] cos {θ}_{1} cos ϕ \} / {f}_{1} \qquad ( 28 )$$

$$m ( {θ}_{1} ) = ⌈ \frac{{f}_{1} tan {θ}_{1} cos ϕ - Δ {y}_{( RA )} - p / 2}{p} ⌉ \qquad ( 29 )$$

Using paraxial approximation and assuming small rotation angle cos ϕ≈1, and additionally choosing M, p, Δy_{RA} such that Mp=2f₁ tan (θₘₐₓ), f₁ tan (θₘₐₓ)+Δy_{RA}+p/2=0. The above equations can be simplified as:

$${θ}_{3 x} ( {θ}_{1} ) = \frac{[ M + 1 - 2 m ( {θ}_{1} ) ] p ϕ}{{f}_{1}} \qquad ( 30 )$$

$${θ}_{3 y} ( {θ}_{1} ) = \frac{2 [ ( {f}_{1} {θ}_{1} + Mp / 2 ) mod p ] - p}{{f}_{1}} \qquad ( 31 )$$

$$m ( {θ}_{1} ) = ⌈ \frac{{f}_{1} {θ}_{1}}{p} + \frac{M}{2} ⌉ \qquad ( 32 )$$

Since θ₁∈[−θₘₐₓ, θₘₐₓ] and m(θ₁)∈[1, M], the range of rescanned angles are:

$${θ}_{3 x} ∈ [ - \frac{M - 1}{{f}_{1}} p ϕ , \frac{M - 1}{{f}_{1}} p ϕ ] \qquad ( 33 )$$

$${θ}_{3 y} ∈ [ - \frac{2 {θ}_{max}}{M} , \frac{2 {θ}_{max}}{M} ] \qquad ( 34 )$$

As a result, with a lens array rotated angle ϕ along the optical axis, a 1D scanner scanning along the y-axis would lead to a 2D rescanned beam scanning over a rectangular region defined by Eq. (33) and Eq. (34), where M equally spaced lines are sequentially scanned. The 2D scanning frame rate thus equals the line rate R of the 1D scanner. Because there are M individual lines being scanned within the field of view, the line scan rate equals MR. This scan field of view is illustrated in FIG. 7B.

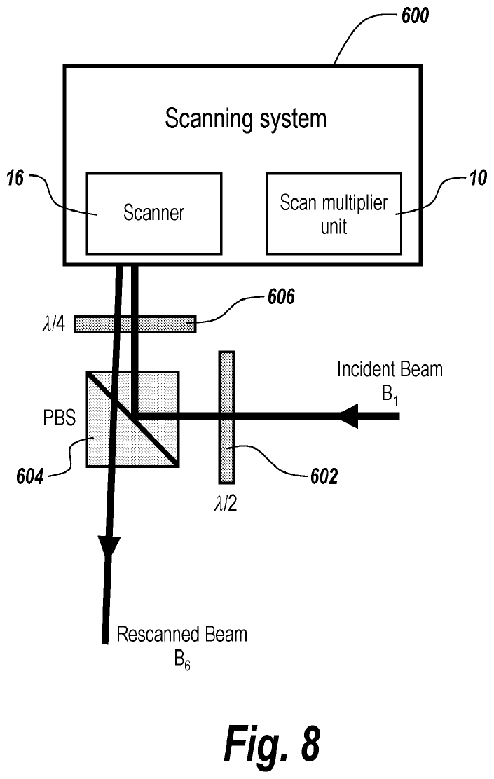

Separating incident and descanned beam. In the embodiments described above, the incident beam B1 and rescanned beam B6 are traveling in opposite directions but along the same optical axis. For some applications it is beneficial to separate B1 and B6 without inducing loss. One of such strategies is shown in FIG. 8, which is a schematic functional diagram illustrating an approach for separating an incident beam and a rescanned beam, according to some exemplary embodiments. Referring to FIG. 8, scanning system 600 includes a laser beam scanner 16 and scan multiplier unit 10, as described above in connection with the various embodiments. In Fig, 8, the polarization of incident laser beam B₁ is first rotated by a half-wave plate (λ/2) 602 so that it is parallel to the reflection axis of polarization beam splitter (PBS) 604, which reflects the beam into scanning system 600, which is representative of any of the embodiments of scanning systems described herein, after passing through a quarter-wave plate (λ/4) 606. Quarter-wave plate 606 converts the incident linearly polarized light into circularly polarized light, and upon retroreflection in scanning system 600, the spin of circular polarization is reversed. As the beam exits scanning system 600, it passes again through quarter-wave plate 606, becoming linearly polarized light with polarization axis perpendicular to the original incident beam B1. Consequently, the rescanned beam B6 transmits through polarization beam splitter 604, separated from the incident beam.

In other embodiments, a single non-polarizing beam splitter can be used instead of PBS 604. Also, incident and descanned beams can be separated by a knife edge mirror, provided that the scan range does not lead to overlap between incident and descanned beams.

Unfolded geometry. When using transmission optics (1D or 2D lens array), such as those illustrated and described above in connection with FIGS. 4, 5 and 6, the system can be unfolded to allow for a single forward pass instead of a forward-backward double pass. An advantage of this single forward pass geometry is that the incident and descanned beam are naturally separated, without the use of polarization optics illustrated and described above in connection with FIG. 8. This can avoid some possible light loss, particularly when the light transmitting through the system is not polarized. One example is confocal fluorescent imaging, if the excitation beam is scanned with the disclosed scan multiplier system of the disclosure, the generated fluorescent signals will also need to pass through the system in the backward direction for descanning. Since fluorescent light is not polarized, descanning thorough the scan multiplier system would cause 50% light loss with the polarization optics illustrated in FIG. 8. This can be avoided by using the single forward pass geometry described herein.

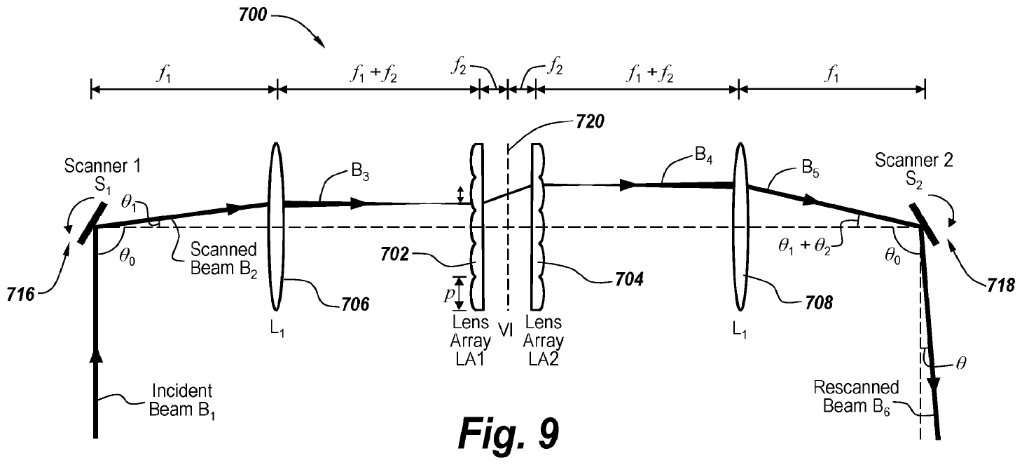

An example of this single forward pass system is shown in FIG. 9, which is a schematic diagram of an unfolded version of the system 300 illustrated in FIG. 4 while the scanning beam transmits through system 700 in a single forward pass, according to some exemplary embodiments. System 700 is unfolded from system 300 of FIG. 4 about the axis of mirror MR 315. System 700 has two identical lenses L1 706 and L2 708, two identical lens arrays LA1 702 and LA2 704, and two identical scanners S1 716 and S2 718. The left lens L1 706 and lens array LA1 702 form a 4f imaging system that images scanner S1 716 to the intermediate virtual image plane VI 720. It is noted that VI 720 is at the same optical position as reflecting mirror MR 315 in FIG. 4. In system 700 of FIG. 9, instead of mirror 315, a combination of lens array LA2 704, lens L2 708 and scanner S2 718, which is a mirrored version of LA1 702, L1 706 and scanner S1 716 are disposed. That is, lens array LA1 702, lens L1 706 and scanner S1 716 are mirror-symmetric to lens array LA2 704, lens L2 708 and scanner S2 718 with respect to the virtual image plane VI 720. This essentially unfolds the system and allows beams to pass through in a single pass, instead of being reflected by a mirror and double passing every element twice. Since two separate scanners 716 and 718 are used in system 700, the motion of the two scanners 716 and 718 is synchronized. Other designs such as the ones shown in FIGS. 5 and 6 can also be unfolded in a similar analogous fashion.

Many variations to the embodiments described herein are within the scope of the present disclosure. For example, retroreflector arrays can have different designs. FIGS. 1 and 3 show the design using wide-angle retroreflector arrays by using hollow roof prisms. Alternative array embodiments such as those using right angle prisms, corner cube prisms or ball lenses are also possible.

In any of the embodiments described herein, the number of individual retroreflectors M>1 can be different.

One implementation of single acceptance angle retroreflector includes a lens array and a mirror, as illustrated in FIGS. 5 and 6. According to the present technology, retroreflector arrays can have wide acceptance angles or just a single acceptance angle.

Instead of a retroreflector array, any optical system that is able to retroreflect a normally incident beam with periodic or aperiodic spatial offsets can be used as the scan multiplier unit.

Instead of using a scan lens and a retroreflector array, any optical system that is able to reflect an incoming beam with periodic angular offsets depending on the incident angle can be used. For example, reconfigurable optics such as a spatial light modulator can be used to replace the lens array for a more flexible scan multiplication control.

For a 1D retroreflector array, the pitch p can be varying instead of constant. For a 2D retroreflector array, the pitch along x-axis pₓ and y-axis p_{y} can also be varying, and do not have to satisfy pₓ=p_{y}. Each individual element could also have a rotation angle with respect to each other.

For a 2D retroreflector array, each individual retroreflector does not need to be arranged orthogonally. Arrays can be arranged in geometries such as trihedral or honeycomb, which will affect the scanning area of the rescanned beam. Each row or each column could also be laterally offset with each other.

For 2D scanning using a 1D retroreflector array, instead of a tilted lens array, the lens array could be laterally offset in the x directions. It could also be replaced with a standard 1D retroreflector array, with each element at varying rotation angles.

The description herein of throughput is limited to a Gaussian laser beam. However, the technology is also applicable to laser beams with other spatial profiles such as a donut beam or a Bessel beam.

The description herein is applicable to different laser beam sources such as continuous lasers, pulse lasers, multi-color laser sources, frequency comb sources, and other analogous or similar sources.

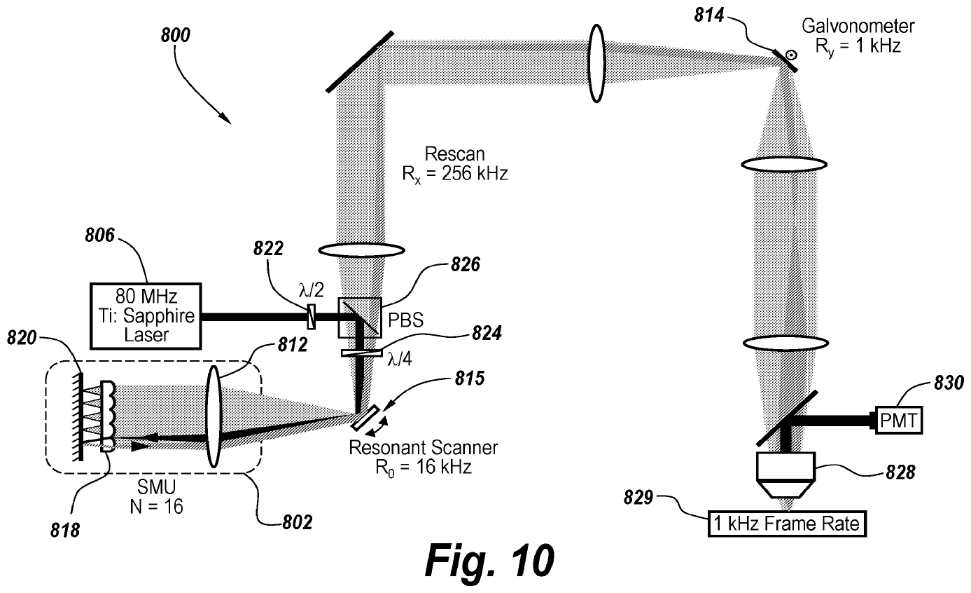

FIG. 10 is a schematic diagram of a two-photon microscope system 800 for 1 kHz frame rate imaging, using a scan multiplier unit (SMU) 802 according to some exemplary embodiments as described herein. A feature in this embodiment is the use of a combination of an 8 kHz resonant scanner (16 kHz bidirectional line rate) and a N=16 SMU 802 for ultrafast 256 kHz fast-axis scanning. With an additional linear galvanometer for 1 kHz slow-axis scanning, one is able to raster scan over a 2D area at 1 KHz frame rate.

Referring to FIG. 10, a laser source 806, such as a Ti-Sapphire laser with 80 MHz repetition rate, is scanned by a resonant scanner 815 with 8 kHz resonant frequency, resulting in a scanned laser beam with 16 kHz bidirectional line rate. This laser beam is directed into SMU 802, which includes lens 812, N=16 lenslet array 818, and a mirror 820. The retroflected laser beam, after passing through resonant scanner 815 a second time, will have a multiplied line scan rate of 256 kHz, which acts as the fast-axis scanning. The incident and rescanned beam are separated using a combination of a half-wave plate 822, quarter-wave plate 824 and a polarization beam splitter (PBS) 826. A 4f system images the surface of resonant scanner 815 onto linear galvanometer 814, which scans the laser beam over the orthogonal axis at 1 kHz line rate. This is then focused onto sample 829 by an objective 828, resulting in a focused spot raster scanned over a 2D field-of-view at 1 kHz frame rate. The generated signal (two-photon fluorescence in this case) is collected by the same objective 828, detected by a photomultiplier tube (PMT) 830, and recorded by a high-speed digitizer. 2D images can be reconstructed in a computer.

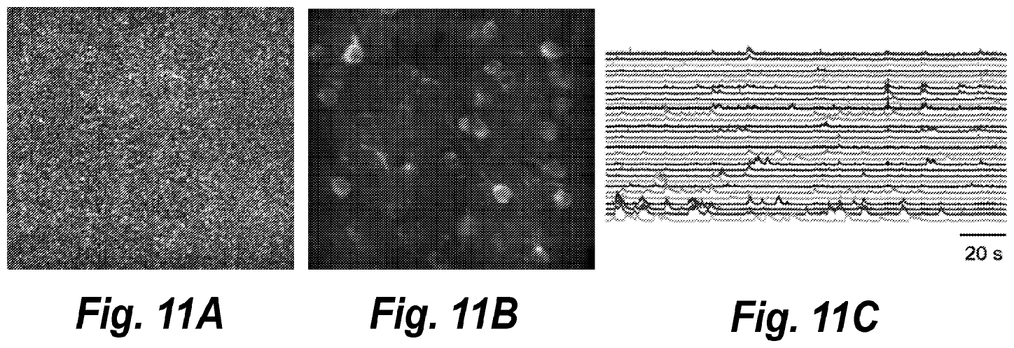

FIGS. 11A-11C illustrate images generated using microscope system 800 of FIG. 10 and corresponding calcium dynamics for in vivo calcium imaging a 1 kHz frame rate over a three-minute recording, according to some exemplary embodiments. Specifically, FIG. 11A illustrates raw frame image data captured at 1 kHz. FIG. 11B illustrates a morphological image containing 31 active neurons during the recording period. FIG. 11C illustrates corresponding calcium dynamics over a 3 min recording. Scale bars in FIGS. 11A and 11B are 20 um.

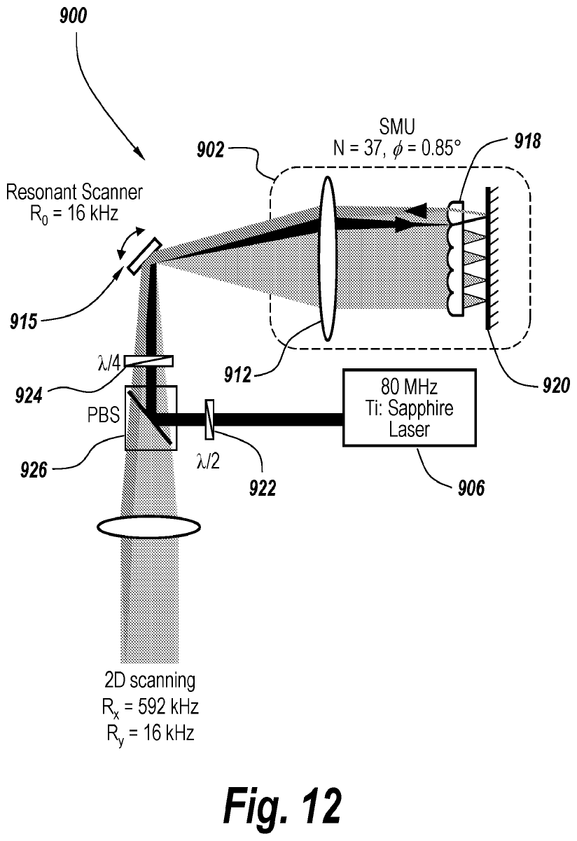

FIG. 12 is a schematic diagram of a two-photon microscope 900 for 16 kHz frame rate imaging, using a scan multiplier unit (SMU) 902 with tilted lenslet array 918, according to some exemplary embodiments. Two-photon microscope 900 uses SMU 900 with tilted lenslet array 918 for ultrafast two-photon microscopy at a 16 kHz frame rate. Laser source 906, such as a Ti-Sapphire laser with 80 MHz repetition rate, provides a beam incident on the surface of 8 kHz resonant scanner 915 (16 kHz line scan rate), and directed into SMU 902, which includes tilted lenslet array 918 with N=37 element, at an 0.85° tilt angle, lens 912, and mirror 920, resulting in a rescanned beam with a fast axis-scan rate of Rₓ=592 kHz, and slow-axis scan rate of R_{y}=16 kHz (which is also the frame rate). The incident and rescanned beam are separated using a combination of a half-wave plate 922, quarter-wave plate 924 and a polarization beam splitter (PBS) 926. The 2D scanned beam is focused onto the sample by an objective, with the focal spot raster scanning over a 2D field of view at 16 kHz frame rate. The generated signal is collected by the same objective, detected by a photomultiplier tube, and recorded by a high-speed digitizer (not shown in FIG. 12, but the same as the elements illustrated in FIG. 10. 2D images can be reconstructed in a computer.

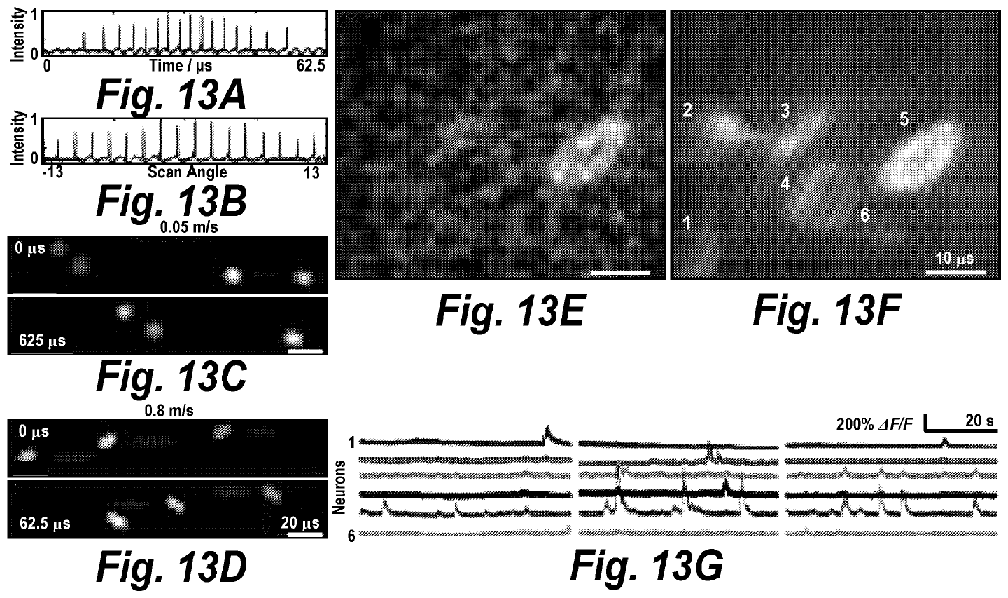

FIG. 13A-13G illustrate imaging aspects using the microscope of FIG. 12, according to some exemplary embodiments. Specifically, FIGS. 13A and 13B illustrate time-resolved signals of a 10 um fluorescent bead scanned at a 256 kHz line rate. FIGS. 13C and 13D are images for fast flow monitoring and in vivo calcium imaging, i.e., 16 kHz imaging of flowing fluorescent beads at different speeds. Image shearing is observed at higher flow speed due to bead motion and bidirectional scanning. FIGS. 13E-13G illustrate images for in vivo calcium imaging a 16 kHz in a single frame (FIG. 13E) and an average frame of six active neurons (FIG. 13F), and calcium traces over three one-minute recordings (FIG. 13G).

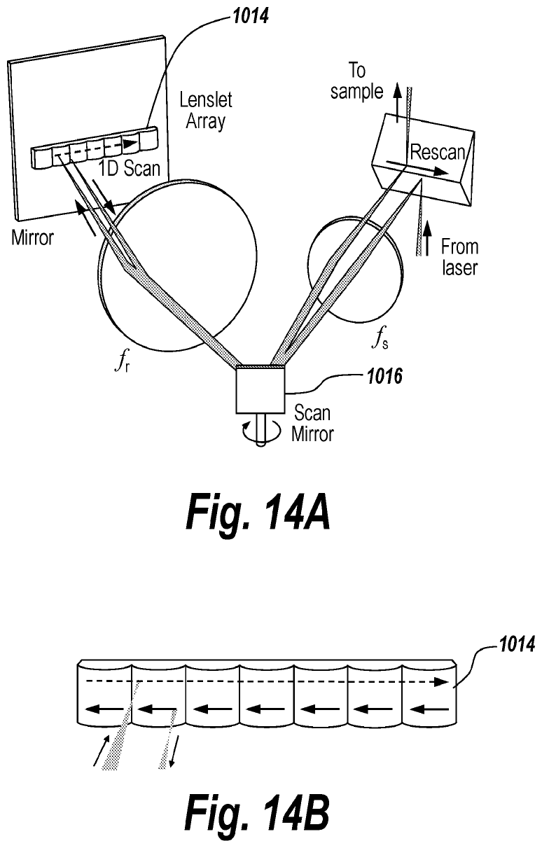

FIGS. 14A and 14B illustrate an approach to separating and outgoing rescanned beam from an incident beam, as applied to confocal microscopy, according to some exemplary embodiments. This is an alternative approach to the approach illustrated in FIG. 8. Compared to the approach shown in FIG. 8, the technique of FIGS. 14A and 14B has an advantage that it does not require polarized light, and can therefore be applied to applications such as confocal microscopy where the rescanned fluorescent photons are unpolarized.

In the embodiment of FIGS. 14A and 14B, the center of the lenslet array 1014 is vertically offset from the scan lines. Due to the 2D structure of the SMU, when the beam exits from the lenslet 1014, it will exit at a different height than the height of the initial 1D scanned beam, as illustrated in FIG. 14B. Thus, the rescanned beam will also be at different height, and they can be easily separated by a leg coated right angle prism mirror.

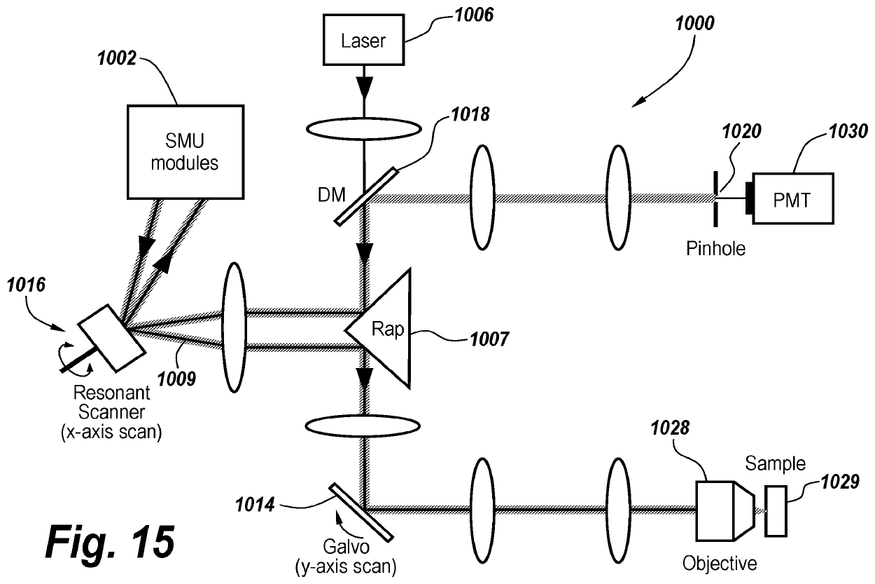

FIG. 15 is a schematic diagram of a confocal microscope system 1000 using a scan multiplier unit 1002 according to some exemplary embodiments as described herein. Referring to FIG. 15, an output beam of a laser source 1006 is directed onto resonant scanner 1016 via the upper leg of right angle prism mirror (RAP) 1007, which is scanning at a predefined line rate of R₀. The beam is transmitted to SMU 1002 with N individual elements, which upon rescan, results in a laser beam with a fast-axis line rate of Rₓ=NR₀. The rescanned beam 1009 is routed via the lower leg of RAP 1007 towards a slow-axis galvanometric scanner 1014 (line rate R_{y}), with a 4f imaging system images the resonant scanner surface onto the galvanometric scanner surface, resulting in a 2D scanned beam with frame rate of R_{y}. This is then reimaged by an additional 4f system onto the back aperture of objective 1028 and this excitation beam is focused onto sample 1029. The resulting emitted fluorescence beam from sample 1029 retraces the path of the excitation beam backwards through galvanometeric scanner 1014, RAP 1007, resonant scanner 1016, and SMU module 1002, which, after being reflected off the upper leg of RAP 1007, is separated from the excitation beam by a dichromatic mirror (DM) 1018. The fluorescent beam is then focused onto a pinhole 1020 for background rejection, and the remaining signal is the collected by photomultiplier tube (PMT) 1030, recorded by a high-speed digitizer. 2D images can be reconstructed in a computer.

It is noted that system 1000 of FIG. 15 is a single-point scanning confocal microscope. It will be understood that the technology of the disclosure can also include other implementations, such as multi-point scanning confocal or line scanning confocal microscopes.

Whereas many alterations and modifications of the disclosure will become apparent to a person of ordinary skill in the art after having read the foregoing description, it is to be understood that the particular embodiments shown and described by way of illustration are in no way intended to be considered limiting. Further, the subject matter has been described with reference to particular embodiments, but variations within the spirit and scope of the disclosure will occur to those skilled in the art. It is noted that the foregoing examples have been provided merely for the purpose of explanation and are in no way to be construed as limiting of the present disclosure.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

### BIBLIOGRAPHY

Bahaa EA Saleh and Malvin Carl Teich. Fundamentals of photonics. john Wiley & sons, 2019. Sven TS Holmstrom, Utku Baran, and Hakan Urey. Mems laser scanners: a review. Journal of Microelectromechanical Systems, 23(2)259-275,2014.
Jean Montagu. Galvanometric and resonant scanners. Handbook of optical and laser scanning, pages 417-476,2004.

Glenn E Stutz. Polygonal scanners: Components, performance, and design. Handbook of optical and laser scanning, page 247,2018.
https://www.cambridgetechnology.com/laser-beam-technology.
https://www.conoptics.com/electro-optic-deflection-systems/.
https://gandh.com/product-categories/deflectors-aodf/.
http://www.isomet.com/index.html.
GRBE Romera and P Bechtoldb. Electro-optic and acousto-optic laser beam scanners-invited paper. Physics procedia, 56:29-39, 2014.
R Salome, Y Kremer, S Dieudonne, J-F Leger, O Krichevsky, C Wyart, D Chatenay, and L Bourdieu. Ultrafast random-access scanning in two-photon microscopy using acousto-optic deflectors. Journal of neuroscience methods, 154(1-2):161-174, 2006.
Paul F McManamon, Philip J Bos, Michael J Escuti, Jason Heikenfeld, Steve Serati, Huikai Xie, and Edward A Watson. A review of phased array steering for narrow-band electrooptical systems. Proceedings of the IEEE, 97(6):1078-1096, 2009.
David N Hutchison, Jie Sun, Jonathan K Doylend, Ranjeet Kumar, John Heck, Woosung Kim, Christopher T Phare, Avi Feshali, and Haisheng Rong. High-resolution aliasing-free optical beam steering. Optica, 3(8): 887-890, 2016.
James Pawley. Handbook of biological con focal microscopy; volume 236. Springer Science & Business Media, 2006.

1. A scan multiplier system for optical scanning, comprising:
an inertial scanning unit for receiving an incident beam and scanning the incident beam to generate a scanned beam defining a scanned line rate; and
a scan multiplier unit for receiving the scanned beam from the inertial scanning unit, the scan multiplier unit including one or more optical elements for redirecting the scanned beam back toward the inertial scanning unit, the inertial scanning unit receiving the reflected beam from the optical element and generating a rescanned beam, the rescanned beam defining a rescanned line rate different from the scanned line rate.

2. The scan multiplier system of claim 1, wherein the incident beam, the scanned beam, and the rescanned beam are optical light beams.

3. The scan multiplier system of claim 1, wherein the rescanned line scan rate of the rescanned beam is greater than the scanned line rate.

4. The scan multiplier system of claim 1, wherein the scan multiplier unit comprises a scan lens and a retroreflector array.

5. The scan multiplier system of claim 1, wherein the optical element in the scan multiplier unit comprises a reflective element.

6. The scan multiplier system of claim 1, wherein the optical element in the scan multiplier unit comprises a plurality of reflective elements at a predetermined pitch.

7. The scan multiplier system of claim 1, wherein the optical element in the scan multiplier unit comprises a plurality of reflective elements at a variable pitch.

8. The scan multiplier system of claim 1, wherein the optical element in the scan multiplier unit comprises a refractive element.

9. The scan multiplier system of claim 1, wherein the optical element in the scan multiplier unit comprises a plurality of refractive elements at a predetermined pitch.

10. The scan multiplier system of claim 1, wherein the optical element in the scan multiplier unit comprises a plurality of refractive elements at a variable pitch.

11. The scan multiplier system of claim 1, wherein the optical element comprises a one-dimensional array of reflective elements.

12. The scan multiplier system of claim 1, wherein the optical element comprises a one-dimensional array of refractive elements.

13. The scan multiplier system of claim 1, wherein the optical element comprises a one-dimensional tilted array of reflective elements.

14. The scan multiplier system of claim 1, wherein the optical element comprises a one-dimensional tilted array of refractive elements.

15. The scan multiplier system of claim 1, wherein the optical element comprises a two-dimensional array of reflective elements.

16. The scan multiplier system of claim 1, wherein the optical element comprises a two-dimensional array of refractive elements.

17. The scan multiplier system of claim 1, further comprising a plurality of optical elements for separating the incident light beam from the rescanned light beam.

18. A laser scanning microscope system, comprising:
a light source for generating an incident light beam;
an inertial scanning unit for receiving the incident light beam and scanning the incident light beam to generate a scanned light beam defining a scanned line rate; and
a scan multiplier unit for receiving the scanned light beam from the inertial scanning unit, the scan multiplier unit including an optical element for redirecting the scanned light beam back toward the inertial scanning unit, the inertial scanning unit receiving the reflected light beam from the optical element and generating a rescanned light beam, the rescanned light beam defining a rescanned line rate different from the scanned line rate.

19. The laser scanning microscope of claim 18, further comprising a plurality of optical elements for separating the incident light beam from the rescanned light beam.

20. The laser scanning microscope of claim 18, further comprising a scanner for scanning the rescanned beam along a slow axis.

21. The laser scanning microscope of claim 18, further comprising an objective for focusing the rescanned light beam onto a focused spot that scans over a sample.

22. The laser scanning microscope of claim 18, further comprising a detector for detecting light from a sample.

23. The laser scanning microscope of claim 22, wherein the detector comprises a two-dimensional array of detector elements.

24. The laser scanning microscope of claim 22, wherein the detector comprises a one-dimensional array of detector elements.

25. The laser scanning microscope of claim 18, wherein the microscope is a confocal microscope.

26. The laser scanning microscope of claim 18, wherein the microscope is a two-photon microscope.
